(19) United States
(12) Patent Application Publication
(10) Pub. No.: US 2004/0103987 A1
(43) Pub. Date: Jun. 3, 2004

(54) Process for producing unitary component and a catheter having a unitary component

(76) Inventors: Thomas Gregory Triebes, Alpharetta, GA (US); Michael Allen Kenowski, Pocatello, ID (US); Donald J. McMichael, South Jordan, UT (US); Netty Dawn DiViesti, Pocatello, ID (US); Daniel Kermit Hill, Blackfoot, ID (US)

Correspondence Address: KIMBERLY-CLARK WORLDWIDE, INC., 401 NORTH LAKE STREET, NEENAH, WI, 54956

(21) Appl. No.: 10/306,994

(22) Filed: Nov. 30, 2002

(51) Int. Cl. B32B 31/00

(52) U.S. Cl. 156/294

(57) ABSTRACT

The present invention relates a process for making a unitary component which may be used with catheters. More specifically, one embodiment of this invention relates to a process for producing a unitary component having a tip integrally formed with a means for expansion. Another embodiment of the present invention relates to a method of producing a catheter having a unitary component wherein the tip of the unitary component is integrally formed with a means for expansion. Other aspects of the present invention will be apparent upon reading the remainder of the disclosure.

### BACKGROUND

Catheterization of a body cavity is frequently performed in medical procedures either to insert substances into or to remove substances from the body. During many of these procedures, it is necessary to keep the catheter in a relatively stable position to perform the desired insertion or removal. With the use of enteral feeding catheters (i.e., catheters which enable the administration of nutritional solutions directly into the stomach or intestines), for example, it is necessary to ensure that the catheter is not accidentally removed from the stomach or intestines. This is true both during the actual administration or removal of fluids, and the time periods in between.

In order to ensure that a catheter is maintained in the proper position, it is common to use a balloon disposed near the distal (patient) end of the catheter shaft. Inflating the balloon causes the balloon to contact the anatomical structure (i.e., a duct or stomach wall) and thereby prevents the catheter from moving out of the proper position. In the case of enteral feeding, a stoma is formed leading into the stomach or intestine. The catheter is positioned to extend through the stoma so as to form a channel into the stomach or intestines through which enteral feeding solutions may be instilled.

FIG. 1 shows a side view of a prior art balloon catheter 10 having a head 14 disposed at a proximal end 15. The head 14 contains valves (not shown) which regulate the flow of fluids through the balloon catheter 10. The head 14 also prevents the balloon catheter 10 from completely advancing through the stoma and into the stomach or intestine of the user.

To prevent the catheter 10 from being pulled out of the stomach/intestinal wall, a balloon 18 is disposed along a catheter shaft 26. The catheter 10 is shown having an optional stiff tip 30, which is attached to the catheter shaft 26 at a distal end 17 opposite the head 14. The catheter shaft 26 is typically made of a medical grade silicone. The stiff tip 30, when present, is also frequently formed of a medical grade silicone but is usually configured to be as rigid as or less rigid than the catheter shaft 26.

The balloon 18 is advantageous because it allows the catheter shaft 26 to be inserted into the stoma (not shown) while the balloon 18 is uninflated. Once the catheter shaft 26 is properly positioned in the stoma, a syringe (not shown) is inserted into a side port 36 of the head 14 and a fluid is injected into the balloon 18 through a lumen (not shown in FIG. 1) of the catheter 10 so as to inflate the balloon 18.

While the balloon 18 remains inflated, the catheter 10 stays properly positioned in the stoma. The position of the balloon catheter 10 is maintained in such a manner until removal is desired. If the catheter 10 needs to be removed, the balloon 18 may be deflated so that it will not interfere with withdrawal of the catheter shaft 26 and stiff tip 30.

The type of balloon 18 shown in FIG. 1 is fashioned around the perimeter of the catheter shaft 26 such that when it is deflated it reduces or contracts about the shaft 26 but is still clearly larger than overall diameter of the catheter.

Attachment of the balloon 18 to the catheter shaft 26 is frequently accomplished by gluing the balloon proximal end 20 and the balloon distal end 22 to corresponding positions on the external surface of the catheter shaft 26 so as to form a proximal cuff 32 and a distal cuff 34, respectively. Such cuffs 32 and 34 are longitudinal sections of the balloon 18 whose inside diameters correspond to the outside diameter of the shaft 26 at their respective points of attachment to the catheter 10 and have a distance between them which is about the length of the uninflated balloon 18. The cuffs 32 and 34 must be of sufficient length to provide a tight and durable seal between the balloon 18 and the catheter shaft 26.

While the prior art balloon configuration shown in FIG. 1 works to maintain the balloon catheter 10 in the proper position within the patient, balloon catheters of this type as well as the other known balloon catheters do have disadvantages. For example, one drawback of prior balloon catheters is discomfort to the user. With regard to the catheter of FIG. 1, in order to allow insertion of the catheter 10, the catheter shaft 26 and especially the stiff tip 30 must be relatively rigid or firm to prevent buckling under insertion pressures. However, this same firmness makes the distal tip 30 much more prone to irritate anatomical structures which come into contact with it. This is especially true in the stomach and intestines where the opposing walls of the anatomical structures tend to collapse on each other during physical exertion or when the cavity has little or no food. As the person moves, the stiff tip 30 repeatedly engages the adjacent anatomical structure (such as the stomach wall) and can lead to irritation and/or discomfort for the user. Thus, as the presence of an extended stiff catheter tip in this environment has been suspected of irritating the opposing surfaces of the body cavity, it would be desirable if the patient could be protected from exposure to the tip 30.

Accordingly, there is a need in the art for a balloon catheter with a stiff distal tip isolated from opposing internal body cavity surfaces.

Another disadvantage with the prior art balloons of the type discussed above, is that if they were to be secured to the interior portion of the tip 30 they would provide undesirable restriction of the flow of fluids therethrough. Although not done in prior catheters, if the tip were to be attached to the interior of the catheter shaft, the flow would be further reduced. The reduction in flow can result in the need for longer use of the catheter to obtain the desired level of fluid flow. If a catheter having a wider tip or shaft is used to overcome the fluid flow issue, the stoma through which the catheter must be inserted will need to be larger thereby creating other issues, such as increased time for the stoma to heal as well as creating a larger opening through which fluids can leak out.

Accordingly, there is a need for a catheter which can provide for an increased level of fluid flow (as compared with prior devices) without the need for a larger stoma opening.

Yet another disadvantage with prior art catheters of the type discussed above is that they generally first require the separate manufacture of multiple pieces (e.g., the catheter, the rigid tip and the balloon), then the attachment of the tip to the catheter and one end of the balloon and, finally, the attachment of the second end of the balloon to the catheter. Each of the attachments methods have been done manually in the past. Naturally, this manual operation is slow, costly and inefficient. Further with each additional step in a process there exists an opportunity for error and waste of product. To avoid the additional production and assembly steps, in many prior catheters the balloon is attached directly to the outside of the catheter without a tip; however, catheters of this sort do not enjoy the benefits the tips may have to offer.

Thus, while there is a need for catheters, because of the number of individual pieces or members which comprise a catheter and because those pieces are typically assembled by hand or at least in multiple assembly steps, there is a need in the art for a catheter which requires less assembly, and specifically less manual assembly.

### SUMMARY OF THE INVENTION

In response to the difficulties and problems discussed above, a process for making a unitary component which may be used with catheters has been developed. More specifically, one embodiment of the invention relates to a process for producing a unitary component having a tip integrally formed with a means for expansion. The process includes providing a mold, providing at least one material for use with the mold, filling the mold with at least one material and removing the unitary component from the mold.

Another embodiment of the present invention relates to a method of producing a catheter having a unitary component wherein the tip of the unitary component is integrally formed with a means for expansion. More specifically, the method includes providing a catheter with a head, a shaft, and a distal end; providing a unitary component having a distal end and a proximal end; attaching the distal end of the unitary component to the distal end of the catheter; and attaching the proximal end of the unitary component to the catheter shaft so as to create a balloon.

The present invention is also directed to a method of producing a unitary component having a tip integrally formed with a means for expansion. The method generally includes providing a coating, providing a core pin, inserting at least a portion of the core pin into the coating, removing the core pin from the coating, curing the coating surrounding the core pin, and removing the core pin from the cured coating so as to produce a unitary component.

Another embodiment of the present invention is directed to a method of producing a unitary component wherein the tip of the unitary component is integrally formed with a balloon. The method includes providing a high consistency material, providing a mold, providing a transfer pot, inserting the material into the transfer pot, allowing the material to transfer from the transfer pot to the mold, and removing the molded material from the mold so as to provide the unitary component.

These and other features and advantages will be seen from the following detailed description of the drawings and from the claims.

### BRIEF DESCRIPTION OF THE DRAWINGS

The above and other objects, features and advantages of the invention will become apparent from a consideration of the subsequent detailed description presented in connection with the accompanying drawings in which:

FIG. 1 is a side view of a prior art balloon catheter in an inflated configuration;

FIG. 2 is a cross-sectional view of an embodiment of a unitary component made in accordance with the present invention having a tip portion and a balloon;

FIG. 3 is a perspective view of an embodiment of the present invention having an uninflated balloon;

FIG. 4 is a perspective view of the embodiment of FIG. 3 with the balloon inflated;

FIG. 5 is a cross-sectional view of the balloon catheter of FIG. 3;

FIG. 5A is an enlargement of the encircled area of FIG. 5;

FIG. 6 is a cross-sectional view of the balloon catheter of FIG. 4;

FIG. 6A is an enlargement of the encircled area of FIG. 6;

FIG. 7 shows an alternate embodiment of the encircled area of FIG. 6; and

FIG. 8 is a cross-sectional view of the balloon catheter similar to that of FIG. 6, except that the proximal end of the unitary component is invertedly attached to the catheter shaft.

### DETAILED DESCRIPTION OF THE PRESENT INVENTION

Reference will now be made to the drawings in which the various elements of the present invention will be given numeral designations and in which the invention will be discussed so as to enable one skilled in the art to make and use the invention. It should be appreciated that each example is provided by way of explaining the invention, and not as a limitation of the invention. For example, features illustrated or described with respect to one embodiment may be used with another embodiment to yield still a further embodiment. These and other modifications and variations are within the scope and spirit of the invention.

As used herein, the term “distal” refers to the direction of the patient and the term “proximal” refers to the direction of the clinician.

It will be appreciated that while reference is made to a means for expansion in the claims and in the first part of the disclosure, the term means for expansion may also mean or include, but is not limited to, a balloon, a sleeve, an elongate sleeve, an expandable sleeve, an expandable region or portion, an inflatable member, any other suitable expandable means, or the like. However, for ease of reading and understanding of this disclosure, and not intending to be limited thereby, the term means for expansion will hereinafter be referred to as a balloon. It will also be appreciated that throughout the disclosure reference is made to inflation of the balloon, however, the present invention is not intended to be limited only to inflation. That is, while inflation is used herein for purposes of ease of reading and understanding the disclosure, the term inflation is also intended to mean or include, but is not limited to, expansion, enlargement, swelling or the like.

Additionally, throughout the disclosure reference is made to a tip for ease of reading and understanding, however, it is not intended to limit in any way the scope of the disclosure. That is, if not for ease of reading and understanding, other terms which are intended to be included within the scope of the term tip, such as, but not limited to, tip member, tip portion, tip region, the portion of the unitary component containing the tip, and the like might otherwise have been used to describe the present invention.

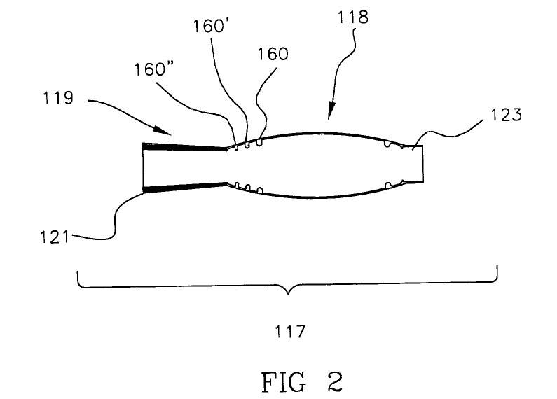

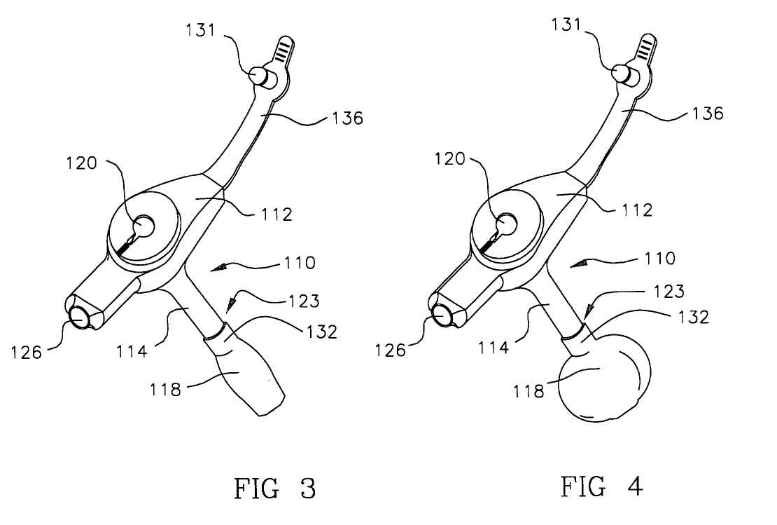

Referring now to FIG. 2, there is shown a unitary component 117 having a tip 119 and a balloon 118. The tip 119 of the component 117 may be stiff or rigid, but is desirably at least as stiff as and/or more rigid than the balloon 118 and/or the catheter shaft 114 (FIG. 3), when present, as described below.

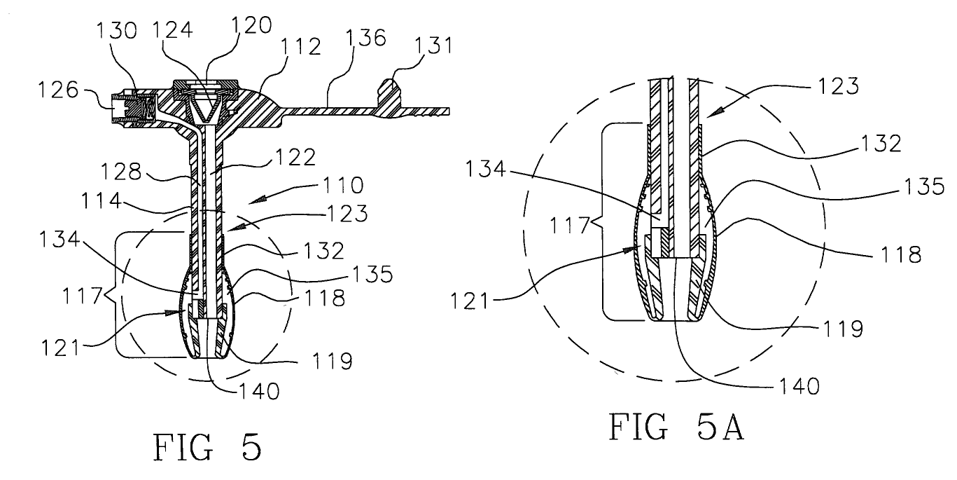

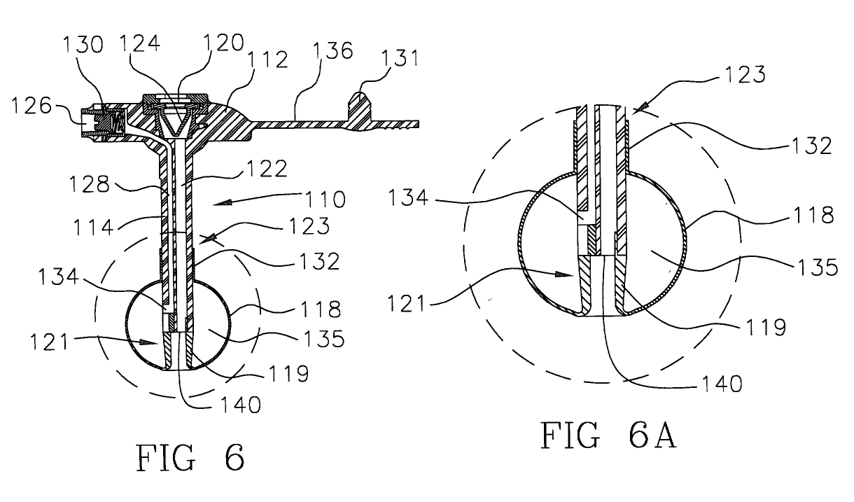

The unitary component 117 of FIG. 2 is generally used in conjunction with a catheter such as balloon catheter 110 in FIGS. 3-8. The catheter 110 includes a proximal head 112, a shaft 114 and a unitary component 117. Referring now to FIGS. 5 and 6, the head 112 has a proximal opening 120 to a feeding lumen 122 within the shaft 114, for bolus feeding or providing other nutrient fluids, formula, or the like to a patient (not depicted). Although not required, an anti-reflux valve 124, which is generally included to prevent back-flow of the nutrient formula, is shown disposed between the opening 120 and the feeding lumen 122. Inflation port 126 is disposed in head 112 and communicates with the inflation lumen 128 which extends longitudinally through the shaft 114. The inflation lumen 128 is shown terminating laterally to the shaft 114 at port 134 into the cavity 135 created by the balloon 118 of the unitary component 117 and the shaft 114, as discussed in more detail below. A one-way valve 130 may be disposed between the inflation port 126 and inflation lumen 128. Application of positive fluid pressure, such as with air or saline, within and/or upon the inflation lumen 128 by way of the inflation port 126 may cause the balloon 118 of the unitary component 117 to inflate. Valve 130 helps prevent inadvertent deflation of the balloon 118. Also shown associated with the head 112 is a plug 131 for the proximal opening 120 and a lanyard 136 for retaining the plug 131 in a ready position. The plug 131 can be inserted in the opening 120 thereby reducing or precluding contamination when the opening 120 is not in use. Feeding lumen 122 extends longitudinally through shaft 114 and is shown terminating at the distal end 140 of the shaft 114.

The various components of balloon catheter 110 may be made of any suitable material and may desirably be formed from bio-compatible materials such as medical grade silicone or the like. While valves 124 and 130 may be formed of any suitable material they are desirably made of a suitable polymer such as polycarbonate.

It will be appreciated that the size of the catheter 110 as well as the length (inflated and uninflated) of the balloon 118 may be varied in accordance with the size and shape of the body cavity (not shown) the catheter 110 is to be used in and the nature of the matter to be moved through the catheter 110. That is, for example, in some instances, it may be desirable to use catheters having larger and/or wider shafts than in other embodiments. Additionally, as discussed in more detail below the balloon 118 of the catheter 110 may be designed to have a certain size and/or shape in either or both of its inflated or uninflated configurations.

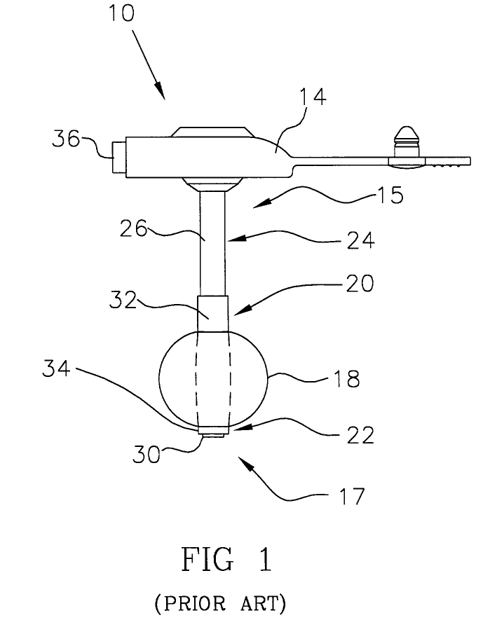

Generally, for ease of prior manufacturing concerns, the catheters and the tips of the prior devices were made separately and later assembled. Reasons for separate manufacture in the past include, but are not limited to, that it was desirable in one or more instances for the tip 30 (FIG. 1) to be made of a material different from that used to construct the catheter 10 (FIG. 1), or if made of the same material for the tip 30 to exhibit different physical properties (e.g., as a result of different processing conditions or steps) from the catheter 10. In either case (i.e. manufactured as one piece (with the catheter) or as multiple pieces), it will be appreciated that the tip 119 (FIGS. 5-8) and shaft 114 (FIGS. 3-8) of the present invention desirably should be able to withstand insertion pressures without binding or buckling.

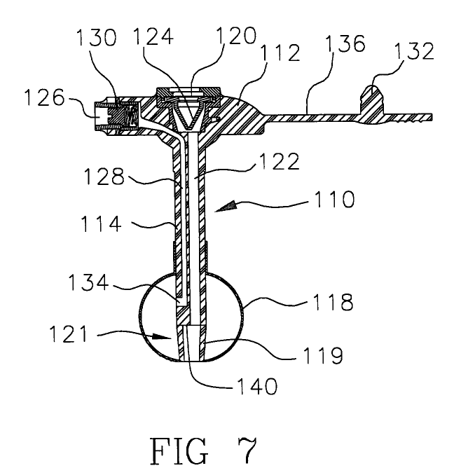

The unitary component 117 of the present invention may be constructed in any number of suitable manners, including, but not limited to, injection molding, transfer molding or dipping. Further, the unitary component 117 may be attached to the catheter 110 in a variety of manners, including, but not limited to, gluing or attachment during one of the injection molding, transfer molding or dipping processes referred to above. The unitary component 117 could also be attached to the catheter 110 by way of chemical bonding, such as solvent bonding. As shown in FIGS. 5 and 5A, unitary component 117 may be attached to the catheter 110 in such a way as to overlap with the distal end 140 of the catheter 110. The overlap may be on the exterior (FIGS. 5 and 5A) of the catheter shaft 114 or the interior (FIGS. 6 and 6A) of the shaft 114. Alternately, as shown in FIG. 7, the unitary component 117 may, for example, be attached to the end 140 of the catheter shaft 114 in such a way that there is little or no overlap and such that little or no restriction of the feeding lumen 122 occurs at the point of attachment between the distal end 121 of the unitary component 117 and the distal end 140 of the catheter 110.

Any of the manners of attachment of the unitary component 117 (FIGS. 2-8) to the catheter shaft 114 discussed above still avoid the undesirable restriction of the flow associated with the prior art tips having the balloon attached to the interior of the tip (thereby reducing the size of the passageway through the tip which is available for fluid communication). Accordingly, the use of a unitary component 117 (FIGS. 2-8) may enable the user to use a tip 119 (FIGS. 5-8) having a smaller cross-sectional area and/or a smaller sized catheter shaft 114 (FIGS. 3-8) as the desired level of fluid flow can be achieved in less time under the same use conditions when compared with prior devices having attachments of the balloon to the interior of the tip. It will be appreciated that there are a number advantages or benefits associated with the ability to use a catheter having a smaller shaft diameter where no adverse effects exist as a result of using the catheter with a smaller shaft diameter.

As shown in FIGS. 2-8, the unitary component 117 is designed such that at least a portion of the balloon 118 of the unitary component 117 may be inverted about or around all or a part of the tip 119 of the unitary component 117.

As noted above, as the composition and/or physical characteristics of the catheter 110 and the tip 119 may vary, so too may the composition and/or the physical characteristics of one or more portions or regions of the unitary component 117. That is, for example, the unitary component 117, will have a thickness, however, the thickness, as well as the weight, shape, or density of one or more portions of the unitary component may vary. More specifically, for example, the portion of the unitary component 117 including tip 119 may have different properties (e.g., durometer, thickness, elasticity, density, etc.) from the portion of the component 117 including the balloon 118.

Additionally, within each region or portion of the unitary component 117, the properties and/or characteristics of the component may vary. For example, the tip 119 may be tapered and/or the portion of the unitary component 117 having the balloon 118 may be more expandable or elastic in some areas than in others. It will be appreciated that while the regions or portions of the unitary component 117 are, in some instances herein, referred to separately, they are in fact part of one component, the unitary component 117. It will also be appreciated that while the regions may generally be referred to as separate regions, there is in fact no hard line as to where one region or portion begins and another ends. Thus, what one may refer to as a transition zone, where a part of a portion or region may exhibit the properties and/or characteristics of two portions or regions, may be found in the unitary component 117. A transition zone may even be found within a portion of a unitary component 117. For example, in the portion of a unitary component 117 containing a balloon 118 having different levels of elasticity, there will exist a transition zone between the areas exhibiting different levels of elasticity.

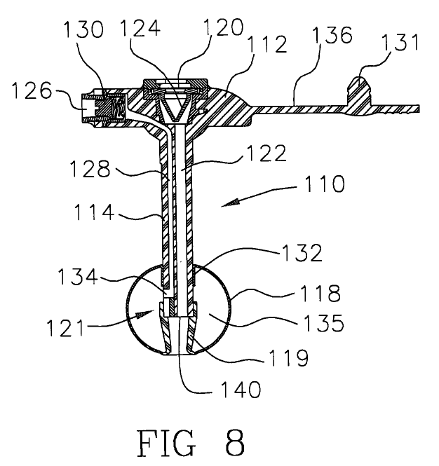

As illustrated in FIGS. 2-4, the unitary component 117 has one end 121 (FIG. 2) adjacent the portion of the unitary component 117 having the tip 119 and a second end 123 adjacent the portion of the unitary component 117 having the balloon 118. The end 123 of balloon 118 which may be inverted about at least part of the tip 119 can be attached to the catheter shaft 114 (FIGS. 3-8) in a variety of suitable manners. For example, the end 123 may be attached to the exterior of the shaft 114 as shown in FIGS. 3, and 4. In those embodiments where the end 123 attaches to the exterior of the catheter 110, the end 123 may be attached so as to form, for example, a cuff 132 (FIGS. 3-7), or the end 123 may be attached in an inverted fashion as shown in FIG. 8 and as discussed in commonly assigned co-pending U.S. patent application Ser. No. ______, entitled “CATHETER HAVING A BALLOON MEMBER INVERTEDLY ATTACHED THERETO”, filed in the names of Letson et al. on Nov. 30, 2002 (Attorney Docket No.18,477), the disclosure of which is herein incorporated by reference in its entirety.

It will be appreciated that the length of the balloon 118 as well as the point along the shaft 114 at which the end 123 of the balloon 118 is attached may effect the shape of the resulting balloon. Another suitable way of controlling the shape of the resulting inflated balloon 118 includes annular rings such as those shown at 160, 160′, and 160″ in FIG. 2. Another way of controlling the shape of the inflatable balloon includes, but is not limited to, rotational dipping, commonly done in the condom industry in order to create a uniform film. Still other suitable ways of controlling the shape of the resulting balloon include, but are not limited to, those discussed in the U.S. Pat. No. 6,264,631 B1 to Willis et al., which is incorporated by reference in its entirety.

Having described a unitary component 117 (FIG. 2) and a catheter 110 (FIGS. 3-8) incorporating a unitary component 117, the disclosure now shifts to another aspect of the present invention, a process for producing a catheter 110 having a unitary component 117 including a tip 119 integrally formed with a balloon 118.

One process of the present invention includes the steps of providing a mold, providing at least one material for use with the mold, filling the mold with at least one material suitable for use with the mold and removing the unitary component from the mold, wherein the unitary component has a tip integrally formed with a balloon. It will be appreciated that the process may further include one or more steps of treating the material. There are many points during the production process at which the material may be treated. For example, the material may be treated prior to filling the mold. One example of this is that the material may need to be treated with heat to allow it to obtain certain characteristics which will enable it to take the shape of the mold. Another example is that the material may need to be mixed or agitated prior to filling of the mold. It will be appreciated that the treatment may vary depending in part upon the material or materials which are provided. It will also be appreciated that the material may be treated while it is in the mold or even after the component is removed therefrom. Again, as an example, but not limited thereto, once in the mold, the material may be subjected an increase or decrease in pressure and/or temperature or otherwise cured. With regard to treatment of the component after removal from the mold, the component may be subjected to, but is not limited to, controlled cooling or heated post-cure. Each of the treatments contemplated by the present invention may provide for the production of unitary components having a vast range of characteristics.

While the materials used to produce the unitary component may be treated before, during or after residing in the mold, the amount of treatment may vary depending on the characteristics sought as well as the material or materials used and the process used. As noted above, any suitable material may be used to construct the unitary component, however, some materials may be better suited than others for particular embodiments. Suitable materials may include, but are not limited to, materials which are, at least in part, a high-strength silicone rubber, a liquid silicone rubber, or a high consistency rubber. Other suitable materials may also include, but are not limited to, PVC, polyurethane, or latex rubber provided their physical properties provide for use under the conditions described herein. As before, the step of filling the mold may be accomplished in any number of suitable manners including, but not limited to, injection molding or transfer molding. It is contemplated that the suitable materials may vary depending on the specific technique used to produce a desired unitary component.

Another method of present invention provides a catheter 110 having a unitary component 117 wherein the tip 119 of the unitary component 117 is integrally formed with a balloon 118. The method generally includes providing a catheter 110 having a head 112, a shaft 114, and a distal end 140, providing a unitary component 117 having a distal end 121 and a proximal end 123, attaching the distal end 121 of the unitary component 117 to the distal end 140 of the catheter, and attaching the proximal end 123 of the unitary component 117 to the catheter shaft 114 so as to create a balloon 118 which is capable of inflation. As described above, the step of providing the unitary component 117 may include, but is not limited to, injection molding, transfer molding or dip molding. One suitable manner in which to accomplish the step of providing the unitary component 117 may generally include providing a mold (not shown), providing at least one material, filling the mold with the at least one material, and removing the unitary component 117 from the mold.

While the unitary component 117 may be attached to a catheter 110 after individual production of the unitary component 117 and the catheter 110 is complete, for a variety of reasons, the process of the present invention which is generally desired produces the component 117 and attaches it to the catheter 110 without the need for later mechanical or manual attachment. Some of the reasons may include, but are not limited to, the reduction or elimination for the need for additional workers or machines to assemble the parts or to operate the machines which assemble the parts, reduction or elimination of the need for attaching or bonding agents, and/or the reduction or elimination of a number of steps in the assembly process. The resulting efficiency increases provided by the present invention which are achieved or which can be expected to be obtained as a result of the reductions suggested above illustrate the value of but one embodiment of the present invention.

Although the unitary component 117 (FIG. 2) may be produced separate from the catheter 110 (FIG. 5) and later assembled with or attached to the catheter 110, the present invention also contemplates the concurrent or substantially concurrent production of the unitary component 117 and attachment of at least the distal end 121 (FIGS. 5 and 6) of the component 117 to the catheter 110. That is, the unitary component 117 may be produced in such a manner that, as the unitary component 117 is produced, it also is attached or begins to be attached to or begins to be formed with the catheter 110. It will be appreciated that the manner in which this occurs will depend in part on the process of producing the unitary component 117. One exemplary way of attaching the distal end 121 (FIGS. 5 and 6) of the unitary component 117 may further include positioning the distal end 140 of the catheter 110 such that the distal end 121 of the unitary component 117 is molded onto the catheter 110. Again the manner in which this may be achieved may vary depending on the molding process. That is, for example, in an injection molding or transfer molding process, at least a portion of the distal end 140 of the catheter 110 may be placed within the mold (not shown), whereas in a dip molding process, in order to mold directly onto the distal end 140 of the catheter 110, at least a portion of the catheter 110 must be placed into the dipping solution.

Although not illustrated, one suitable way of performing the method described above is wherein a catheter 110 is passed along a conveyor (not shown) in such a manner that the distal end 140 of the catheter 110 enters or is positioned within a mold (not shown) of a unitary component, such that when the mold is filled with material the mold produces a unitary component 117 which is attached to or about the distal end 140 of the catheter shaft 124. It will be recognized that the process mentioned immediately above is just one of many that is contemplated to be within the scope of the present invention. For example, instead of using a conveyer (not shown) to pass the catheters 110 into position within the mold, many other ways of accomplishing this portion of the process are possible. That is, the catheters 110 could be manually positioned within the mold or they could be dropped into the mold by a chute (not shown) or the like which is filled with catheters 110 such that when the mold is opened the next catheter 110 in the chute falls into position within the mold where the unitary component 117 is molded thereto.

As noted above the unitary component 117 may be attached to the catheter 110 in a separate step. This separate attachment step may be performed manually or it may be automated. Although the components may be combined without exposure to an adhesive, bonding agent, elevated temperature or the like, the resulting attachment is not fixed. As such, depending on the embodiment in question, the step of attaching the distal end 140 of the catheter 110 to the unitary component 117 may be achieved, for example, by gluing the parts together. Alternatively, the parts may be chemical bonded to one another. It will be appreciated that the gluing or chemical bonding of the parts are just two examples of suitable attachment steps. Other suitable attachment steps include, but are not limited to, subjecting the connected pieces to an elevated temperature so as to cause one or both components to attach or bond to the other.

Having discussed the attachment of the distal end 121 (FIGS. 5 and 6) of the unitary component 117 to the catheter 110 (FIG. 3) in some detail above, it is noted that the proximal end 123 (FIGS. 3-6) of the unitary component 117 may also be attached to the catheter 110 in a variety of suitable manners. Suitable manners of attaching the proximal end 123 of the unitary component 117 may also include, but are not limited to, adhesives, chemical bonding, exposure to elevated temperatures, other bonding agents and the like. It is appreciated that the proximal end 123 of unitary component 117 may be attached to or about the catheter shaft 114 in a generally smooth or flat manner so as to form, for example, a cuff 132 as shown in FIGS. 3 and 4 or the proximal end 123 of the balloon 118 may be inverted as shown in FIG. 8 and discussed above and in more detail in commonly assigned and co-pending U.S. patent application Ser. No. ______, entitled “CATHETER HAVING A BALLOON MEMBER INVERTEDLY ATTACHED THERETO” (Attorney Docket No.18,477).

The present invention also is directed to another method for producing a unitary component. The method for producing the component having a tip integrally formed with a balloon may include providing a coating (not shown), providing a core pin or mandrel (not shown), inserting at least a portion of the core pin into the coating, removing the core pin from the coating, curing the coating surrounding the core pin, and removing the core pin from the cured coating so as to produce a unitary component. The method may further include repeating the steps of inserting at least a portion of the core pin into the coating and removing the core pin from the coating. This repetition will allow for the thickness of the unitary component to be controlled.

It also will be appreciated that the method may include providing a catheter having a distal end with at least one opening therein and inserting at least a portion of the core pin into the opening in the distal end of the catheter. This generally will be done such that the opening or lumen (e.g., feeding lumen 122 (FIGS. 5-8) of the catheter 110 does not become obscured during the production of the unitary component. If a core pin or mandrel is used, the method will also include the step of removing the core pin. It is desired that the insertion and removal of the core pin (not shown) into and from the opening in the distal end 140 (FIGS. 5-8) of the catheter 110 (FIGS. 3-8) be done in such a way that the unitary component 117 (FIGS. 3-8) may be formed onto or about the distal end 140 (FIGS. 5-8) of the catheter 110 (FIGS. 3-8).

The step of curing the coating surrounding the core pin may include, but is not limited to, subjecting the coating around the core pin to certain temperature and/or pressure conditions. It is recognized and appreciated that the curing conditions may vary in part because of the materials selected for use. All such suitable conditions are contemplated.

As mentioned above, the coating may be any suitable combination of materials which may be used to produce a unitary component. Suitable coatings for use in the above method may include, but are not limited to, a silicone/solvent dispersion. Where a silicone/solvent dispersion is used, the method may further include a step of flashing off the solvent once the core pin is removed from the coating/dispersion.

Another aspect of the present invention is directed to a method of producing a unitary component wherein the tip of the unitary component is integrally formed with a balloon. The method generally includes providing a high consistency material, providing a mold (not shown), providing a transfer pot (not shown), receiving the material into the transfer pot, allowing the material to transfer from the transfer pot to the mold, and removing the molded material from the mold so as to provide the unitary component. The method may also include the step of curing the material so as to form the unitary component. Any suitable method of inserting the material into the transfer pot is acceptable. Also, it will be recognized that there are a variety of materials which may be used in this embodiment of the present invention and that the characteristics of each may necessitate different operating conditions for the insertion of the material in to the transfer pot and/or the transfer of material from the transfer pot. All such variations of operating conditions are contemplated by the present invention. For example, a material may be provided under pressure from the transfer pot to the mold. By way of further example, the material may be also be heated prior to, during, or after such a transfer.

While the invention has been described in detail with respect to specific embodiments thereof, those skilled in the art, upon obtaining an understanding of the invention, may readily conceive of alterations to, variations of, and equivalents to the described embodiments. It is intended that the present invention include such modifications and variations as come within the scope of the appended claims and their equivalents.

What is claimed is:

1. A process for producing a unitary component comprising:
providing a mold;
providing at least one material;
filling the mold with at least one material; and
removing from the mold the unitary component having a tip integrally formed with a means for expansion.

2. The process of claim 1 further comprising the step of treating the material in the mold.

3. The process of claim 2 further comprising curing the material.

4. The process of claim 1 further comprising the step of treating the material prior to filling the mold with the material.

5. The process of claim 1 wherein the material comprises at least in part a high-strength silicone rubber.

6. The process of claim 1 wherein the material comprises at least in part a liquid silicone rubber or a high consistency rubber.

7. The process of claim 1 wherein the step of filling the mold may be selected from injection molding or transfer molding.

8. A method of producing a catheter having a unitary component wherein the tip of the unitary component is integrally formed with a means for expansion, the method comprising:
providing a catheter with a head, a shaft, and a distal end;
providing a unitary component having a distal end and a proximal end;
attaching the distal end of the unitary component to the distal end of the catheter; and
attaching the proximal end of the unitary component to the catheter shaft so as to create a balloon.

9. The method of claim 8 wherein the step of providing the unitary component comprises:
providing a mold;
providing at least one material;
filling the mold with at least one material; and
removing the unitary component from the mold.

10. The method of claim 8 wherein the step of attaching the distal end of the unitary component further comprises positioning the distal end of the catheter such that the distal end of the unitary component is molded onto the catheter.

11. The method of claim 10 wherein at least a portion of the distal end of the catheter is placed within the mold.

12. The method of claim 8 wherein the step of attaching the distal end of the unitary component to the catheter comprises the step of chemical bonding.

13. The method of claim 8 wherein the step of attaching the distal end of the unitary component to the catheter comprises a step of gluing.

14. The method of claim 8 wherein the proximal end of the unitary component is invertedly attached to the catheter.

15. A method of producing a unitary component comprising a tip integrally formed with a means for expansion, the method comprising:
providing a coating;
providing a core pin;
inserting at least a portion of the core pin into the coating;
removing the core pin from the coating;
curing the coating surrounding the core pin; and
removing the core pin from the cured coating so as to produce a unitary component.

16. The method of claim 15 further comprising repeating the steps of
inserting at least a portion of the core pin into the coating; and
removing the core pin from the coating.

17. The method of claim 15 further comprising:
providing a catheter having a distal end with at least one opening therein;
inserting at least a portion of the core pin into the opening in the distal end of the catheter; and
removing the core pin;
thereby forming the unitary component onto the distal end of the catheter.

18. The method of claim 15 wherein the coating is a silicone/solvent dispersion.

19. The method of claim 18 further comprising the step of flashing of solvent.

20. A method of producing a unitary component wherein the tip of the unitary component is integrally formed with a means for expansion, the method comprising:
providing a high consistency material;
providing a mold;
providing a transfer pot;
inserting the material into the transfer pot;
allowing the material to transfer from the transfer pot to the mold; and
removing the molded material from the mold so as to provide the unitary component.

21. The method of claim 20 further comprising the step of curing the material so as to form the unitary component.
